(19) United States
(12) Patent Application Publication
(10) Pub. No.: US 2026/0320127 A1
(43) Pub. Date: Oct. 15, 2026

(54) METHOD FOR EXTRACTING DOCUMENT INFORMATION, DEVICE AND STORAGE MEDIUM

(71) Applicant: JIANGSU XCMG STATE KEY LABORATORY TECHNOLOGY CO., LTD., Jiangsu (CN)

(72) Inventors: Bin Wang, Jiangsu (CN); Hanshuang Li, Jiangsu (CN); Qian Wang, Jiangsu (CN)

(21) Appl. No.: 18/837,726

(22) PCT Filed: Apr. 29, 2024
(86) PCT No.: PCT/CN2024/090583

§ 371 Date: Aug. 12, 2024

(30) Foreign Application Priority Data
Dec. 20, 2023 (CN) 202311760500.0

(51) Int. Cl. G06F 16/901; G06F 16/903; G06F 16/93

(52) U.S. Cl. CPC G06F 16/9027; G06F 16/90335; G06F 16/93

(57) ABSTRACT

The present disclosure provides a method for extracting document information, device and storage medium, and relates to the field of computer technology. The method for extracting document information includes: performing a first parsing on a document to be processed to obtain an order of nodes in the document to be processed; performing a second parsing on the document to be processed to obtain information contained in the nodes in the document to be processed; constructing a document tree according to the order of nodes in the document to be processed and the information contained in the nodes in the document to be processed; determining a category of a software quality index to which one of the nodes in the document tree belongs, based on a trained machine learning model; extracting information of the software quality index from the nodes in the document tree according to an extraction rule corresponding to the category of the software quality index.

### CROSS-REFERENCE TO RELATED APPLICATIONS

The present application is based on and claims priority of Chinese application for application No. 202311760500.0, filed on Dec. 20, 2023, the disclosure of which is hereby incorporated into the present disclosure by reference in its entirety.

### TECHNICAL FIELD

The present disclosure relates to the field of computer technology, in particular to a method for extracting document information, device and storage medium.

### BACKGROUND

In the whole software life cycle, effectively measuring software quality is helpful to the management and improvement of software, which is of great significance to developers and users. In software development, the information needed to evaluate software quality is usually scattered in multiple documents, such as requirements documents, design documents, test documents, maintenance documents and user manuals.

In related technologies, information in documents is extracted based on extraction rules or based on machine learning model.

### SUMMARY

The present disclosure provides a method for extracting document information, device and storage medium.

According to a first aspect of the present disclosure, there is provided a method for extracting document information, comprising: performing a first parsing on a document to be processed to obtain an order of nodes in the document to be processed; performing a second parsing on the document to be processed to obtain information contained in the nodes in the document to be processed; constructing a document tree according to the order of nodes in the document to be processed and the information contained in the nodes in the document to be processed; determining a category of a software quality index to which one of the nodes in the document tree belongs, based on a trained machine learning model; extracting information of the software quality index from the nodes in the document tree according to an extraction rule corresponding to the category of the software quality index.

In some embodiments, the determining a category of a software quality index to which one of the nodes in the document tree belongs, based on a trained machine learning model comprises: constructing an input vector according to the order of the nodes in the document to be processed and the information contained in the nodes in the document to be processed; processing the input vector by using the trained machine learning model, to obtain the category of the software quality index to which one of the nodes in the document tree belongs.

In some embodiments, the trained machine learning model is a bidirectional encoder representations from transformers model.

In some embodiments, the document to be processed is a word document, and the performing a second parsing on the document to be processed to obtain information contained in the nodes in the document to be processed comprises: constructing a document object instance based on the document to be processed; and extracting information contained in the nodes from the document object instance, according to types of the nodes in the document to be processed.

In some embodiments, the types of the nodes comprise at least one of paragraph, table or directory, and the type of the paragraph comprises at least one of picture or text.

In some embodiments, the information of the nodes includes hierarchical representation information of the nodes, and the constructing a document tree according to the order of nodes in the document to be processed and the information contained in the nodes in the document to be processed comprises: traversing the nodes in the document to be processed according to the order of the nodes in the document to be processed; determining a hierarchical structure to which the nodes in the document to be processed belong, according to the hierarchical representation information of the nodes in the document to be processed; and constructing the document tree according to the hierarchical structure to which the nodes in the document to be processed belong and the information contained in the nodes in the document to be processed.

In some embodiments, the hierarchical representation information of the nodes includes at least one of prefix information of the nodes or a text style of the nodes, and whether the nodes are header text.

In some embodiments, the determining a hierarchical structure to which the nodes in the document to be processed belong, according to the hierarchical representation information of the nodes in the document to be processed comprises: in a case where the i-th node in the document to be processed is a header text, determining whether there is a traversed node that matches at least one of the prefix information or the text style of the i-th node, wherein i is an integer greater than 1 and less than N; in a case where there is the traversed node that matches at least one of the prefix information or the text style of the i-th node, the i-th node and the matched traversed node are at a same level; in a case where there is no traversed node that matches at least one of the prefix information or the text style of the i-th node, the i-th node is the next level of the lowest level among the traversed nodes. N is the total number of nodes.

In some embodiments, the determining a hierarchical structure to which the nodes in the document to be processed belong, according to the hierarchical representation information of the nodes in the document to be processed further comprises: in a case where the i-th node in the document to be processed is non-header text and the previous node of the i-th node is header text, the i-th node is the next level of the previous node.

In some embodiments, the determining a hierarchical structure to which the nodes in the document to be processed belong, according to the hierarchical representation information of the nodes in the document to be processed further comprises: in a case where the i-th node in the document to be processed is non-header text, and the previous node of the i-th node is non-header text, determining at least one of whether the prefix information of the i-th node matching the prefix information of a previous node of the i-th node or whether the text style of the i-th node matching the text style of the previous node of the i-th node; in a case where the determination of at least one of whether the prefix information of the i-th node matching the prefix information of a previous node of the i-th node or whether the text style of the i-th node matching the text style of the previous node of the i-th node is yes, the i-th node and the previous node of the i-th node are at a same level; in a case where the determination of at least one of whether the prefix information of the i-th node matching the prefix information of a previous node of the i-th node or whether the text style of the i-th node matching the text style of the previous node of the i-th node is no, the i-th node is the next level of the previous node of the i-th node.

In some embodiments, the document to be processed is a word document, and the performing a first parsing on a document to be processed to obtain an order of nodes in the document to be processed comprises: modifying a suffix of the document to a compressed file format to obtain a compressed package; decompressing the compressed package to obtain a target folder, the target folder comprising a document file in XML format; parsing the document file in XML format to obtain the order of nodes in the document to be processed.

In some embodiments, the extraction rule comprises a regular matching rule.

According to a second aspect of the present disclosure, there is provided a device for extracting document information, comprising: a first parsing module configured for performing a first parsing on a document to be processed to obtain an order of nodes in the document to be processed; a second parsing module configured for performing a second parsing on the document to be processed to obtain information contained in the nodes in the document to be processed; a constructing module configured for constructing a document tree according to the order of nodes in the document to be processed and the information contained in the nodes in the document to be processed; a categorizing module configured for determining a category of a software quality index to which one of the nodes in the document tree belongs, based on a trained machine learning model; and an extracting module configured for extracting information of the software quality index from the nodes in the document tree according to an extraction rule corresponding to the category of the software quality index.

According to a third aspect of the present disclosure, there is provided a device for extracting document information, comprising: a memory; and a processor coupled to the memory, the processor being configured to execute the method for extracting document information as described above based on instructions stored in the memory.

According to a fourth aspect of the present disclosure, there is provided a computer storable medium, on which a computer program instruction is stored, and the instruction, when executed by a processor, implements the method for extracting document information as described above.

By means of the following detailed description of exemplary embodiments of the present disclosure with reference to the drawing attached thereto, further features and advantages of the present disclosure will become clearer.

### BRIEF DESCRIPTION OF THE DRAWINGS

The accompanying drawings, which form part of the description, illustrate embodiments of the present disclosure and together with the description, serve to explain principles of the present disclosure.

The present disclosure can be more clearly understood from the following detailed description with reference to the accompanying drawings.

FIG. 1 is a flowchart of a method for extracting document information according to some embodiments of the present disclosure.

FIG. 2 is a flowchart of constructing a document tree according to some embodiments of the present disclosure.

FIG. 3 is a flowchart of a document tree constructed according to some embodiments of the present disclosure.

FIG. 4 is a flowchart of determining a hierarchical structure of nodes according to some embodiments of the present disclosure.

FIG. 5 is a schematic structural block diagram of a device for extracting document information according to some embodiments of the present disclosure.

FIG. 6 is a schematic structural diagram of a device for extracting document information according to some other embodiments of the present disclosure.

FIG. 7 is a schematic structural diagram of a computer system according to some embodiments of the present disclosure.

### DETAILED DESCRIPTION

Various exemplary embodiments of the present disclosure will now be described in detail with reference to the accompanying drawings. It should be noted that, unless otherwise specified, elements and arrangement of steps relative to one another, numeric expressions and values recited in these embodiments do not restrict the scope of the present disclosure.

Besides, it should be understood that, in order to facilitate illustration, dimensions of elements shown in the drawings are not given according to the actual scaling relation.

The below description of at least one exemplary embodiment is actually only illustrative, and should by no means be taken as any restriction over the present disclosure and its application or use.

For technology, process and apparatus already known by a person skilled in the related art, detailed discussion may not be given, but if appropriate, such technology, process and apparatus should be regarded as part of the description.

In any example shown or discussed here, any specific value should be interpreted only as being exemplary, rather than being restrictive. Thus, other examples of exemplary embodiments may have different values.

It should be noted that, as like reference signs in the below figures denote like elements, once an element is defined in a figure, it does not need to make further discussion for it in a subsequent figure.

In order to make the objective, technical solution and advantages of the present disclosure more clear, the present disclosure will be further described in detail with reference to specific embodiments and drawings.

The inventor of the present disclosure has found that the method for extracting document information in the related art has the problems of low information extraction accuracy and poor extraction efficiency. How to extract the required software quality evaluation information from documents efficiently and accurately is still a challenging problem.

In view of this, the present disclosure provides a method for extracting document information, device, electronic apparatus and storage medium to improve the efficiency and accuracy of software quality index extraction.

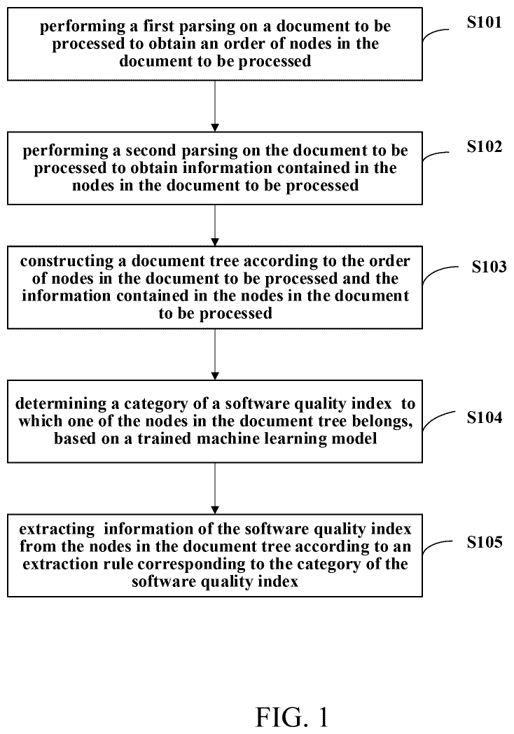

FIG. 1 is a flowchart of a method for extracting document information according to some embodiments of the present disclosure. As shown in FIG. 1, the method for extracting document information comprises steps S101 to S105.

Step S101 comprises performing a first parsing on a document to be processed to obtain an order of nodes in the document to be processed.

In some embodiments, the method for extracting document information is implemented by a device for extracting document information.

In some embodiments, the document to be processed is a word document. For example, the document to be processed is a word document with a suffix of docx.

Nodes in the document to be processed can also be called elements. The type of the node comprises at least one of paragraph, table or directory. Paragraph can be divided into picture and text.

In some embodiments, the document to be processed is a word document, and the performing a first parsing on a document to be processed comprises: modifying a suffix of the document to a compressed file format to obtain a compressed package; decompressing the compressed package to obtain a target folder, the target folder comprising a document file in XML format; and parsing the document file in XML format to obtain the order of nodes in the document to be processed.

In some examples, name of the suffix of the word document to be processed is changed from “docx” to “zip” to obtain a compressed package, and then the compressed package is decompressed to obtain a target folder. The target folder contains multiple document files in Extensible Markup Language (XML) format, such as document. xml file. Next, parsing the document. xml file based on the etree.parse method in Lxml library to get an ElementTree object, and then obtaining an order of nodes by traversing all the nodes in the ElementTree object, and storing the order of the nodes. Lxml library is a parser that can parse XML files, and its main function is to parse and extract data from XML files.

In some examples, the order of the nodes is stored in a list. The order of the nodes includes a whole number and a local number. The whole number is the number obtained by sorting all types of nodes in the sequence in the document, and the local number is the number obtained by sorting nodes of the same type in the sequence in the document. For example, the whole numbers are 001, 002, 003, 004, 005, 006, wherein 001 to 003 are the whole numbers of the nodes of paragraph type, and the local numbers of the nodes of these three paragraph types are (p,0), (p,1) and (p, 2); 004 is the whole number of the node of table type, and the local number of the node of table type is (t, 0); 005 to 006 are the whole numbers of the nodes of paragraph type, and the local numbers of the nodes of these two paragraph types are (p,3) and (p,4).

Step S102 comprises performing a second parsing on the document to be processed to obtain information contained in the nodes in the document to be processed.

In some embodiments, the document to be processed is a word document, and the performing a second parsing on the document to be processed comprises: constructing a document object instance based on the document to be processed; and extracting information contained in the nodes from the document object instance, according to types of the nodes in the document to be processed.

In some embodiments, the type of the node comprises at least one of paragraph, table or directory, and the type of the paragraph comprises at least one of picture or text. In some examples, the picture comprises a visio diagram.

In some examples, a document object instance of the document to be processed is constructed by using Python docx library. Python docx library is a third-party library for processing word documents. It directly operates on word documents, supports reading, querying and modifying Docx or the like format files, and can facilitate us to read node information such as paragraphs and tables efficiently.

In some embodiments, information of the nodes is extracted from the document to be processed according to an extraction means corresponding to the types of the nodes and the order of nodes determined in step S101.

In some examples, in a case where the type of the node is paragraph, information contained in the paragraph is extracted in the following manners: determining whether the paragraph is a picture or text; if the paragraph is a picture (such as a visio diagram), querying the information contained in the picture based on a storage path of the picture; if the paragraph is text, querying the information contained in the text based on a storage path of the text.

In some examples, if the paragraph is a picture, such as a visio diagram, firstly, an instance of a visio object is constructed, and then based on the instance of the visio object, the information of the visio diagram is obtained from a storage path of the visio diagram and stored.

For example, whether the paragraph object contains a <w: object > tag is queried based on XML query language Xpath. If the paragraph object contains a <w: object > tag, whether the <w: object > tag contains a <o:OLEObject > tag is found out by using the getElementsByTagName method. If the tag <o:OLEObject > is contained, an RID attribute is obtained by using the getAttribute method, and a storage path of the picture is found out according to the RID attribute, then information of the picture is extracted according to the storage path of the picture.

In some examples, if the paragraph is text, a storage path of the text is found out, and paragraph style, font size, paragraph type (such as whether it is a title or not), text information in the paragraph, prefix information of the paragraph and so on is extracted from the storage path of the text.

In some examples, when extracting a prefix of a paragraph, in a case where there is no automatic number prefix, it is determined whether there is a conventional prefix. If there is a conventional prefix, the prefix is intercepted. If there is no conventional prefix, the prefix is marked as empty. In a case where there is an automatic number prefix, the prefix is extracted.

In some examples, in a case where the type of the node is table, information in the table is queried according to a storage path of the table. For example, from the <w: tbl > tag in the document object instance information of each cell in the table is extracted by row and column and stored.

In some examples, in a case where the type of the node is directory, information in the directory is queried according to a storage path of the directory. For example, from the <w: sdt > tag in the document object instance, information of text of each line in the directory is extracted and stored.

In some embodiments, a first parsing step and a second parsing step is performed based on different parsing tools. For example, the first parsing step is performed based on the Lxml library and the second parsing step is performed based on the Python docx library. By combining the above two parsing tools, it is helpful to improve the efficiency of document information extraction.

Step S103 comprises constructing a document tree according to the order of the nodes in the document to be processed and the information contained in the nodes in the document to be processed.

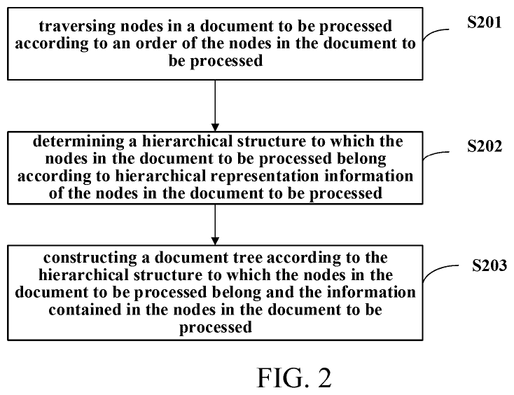

In some embodiments, a document tree is constructed according to the flow as shown in FIG. 2.

Step S104 comprises determining a category of a software quality index to which one of the nodes in the document tree belongs based on the trained machine learning model.

In some embodiments, in step S104, an input vector is constructed according to information contained in the nodes in the document to be processed; the input vector is processed to get the category of the software quality index of each of the nodes in the document tree by using the trained machine learning model.

In some embodiments, in step S104, an input vector is constructed according to the order of the nodes in the document to be processed and the information contained in the nodes in the document to be processed; the input vector is processed to get the category of the software quality index of the nodes in the document tree by using the trained machine learning model.

In some examples, the category of the software quality index to which a node belongs includes one or more of first-class indexes such as functional adaptability, performance efficiency, compatibility, usability, reliability, information security, maintainability and portability. Through the trained machine learning model, the category of the software quality index to which each node belongs can be determined, which is convenient for subsequently rapid and accurate extraction of finer-grained index information.

In some examples, the trained machine learning model is a Bidirectional Encoder Representations from Transformer (BERT) model. Bert model uses a bidirectional Transformer model with Self-Attention mechanism to learn and obtain the semantic relationship between sentences, which can be used to analyze and obtain the semantic expression of text language more conveniently.

In some examples, information contained in the node is preprocessed before using the trained BERT model. The preprocessing comprises segmenting text contained in the node. For example, text content in the node is segmented by using the BertTokenizer method in the transformers package.

In some examples, before using the trained BERT model, an optimization solution is performed on a loss function of the BERT model based on the stochastic gradient descent method.

In the embodiment of the present disclosure, when determining a type of a node based on the machine learning model, an order of a node and information contained in the node are comprehensively considered, to improve the accuracy of node classification.

Step S105 comprises extracting information of the software quality index from the nodes in the document tree according to an extraction rule corresponding to the category of the software quality index.

In some embodiments, the extraction rule comprises a regular matching rule. Regular matching rule is a matching rule corresponding to a specific index contained in the category of the software quality index.

For example, in a case where the category of the software quality index to which a node belongs is functional adaptability, a specific index included in this category is one or more of functional coverage, functional correctness, functional suitability of a target and functional suitability of a system, and the regular matching rule corresponding to these specific indexes comprises one or more of regular matching rules corresponding to functional coverage, functional correctness, functional suitability of a target and functional suitability of a system.

For example, in a case where the category of the software quality index to which a node belongs is performance efficiency, the specific index included in this category is one or more of average response time, adequacy of response time, average turnaround time, adequacy of turnaround time, average throughput, average processor occupancy, average memory occupancy, average input/output device occupancy, bandwidth occupancy, transaction capacity, user visits, and adequacy of user access growth. The regular matching rule corresponding to these specific indexes comprises: one or more of a regular matching rule corresponding to average response time, a regular matching rules corresponding to adequacy of response time, a regular matching rule corresponding to average turnaround time, a regular matching rule corresponding to adequacy of turnaround time, a regular matching rule corresponding to average throughput, a regular matching rule corresponding to average processor occupancy, a regular matching rule corresponding to average memory occupancy, a regular matching rule corresponding to average input/output device occupancy, a regular matching rule corresponding to bandwidth occupancy, a regular matching rule corresponding to transaction capacity, a regular matching rule corresponding to user visits, and a regular matching rule corresponding to adequacy of user access growth.

In some examples, the regular matching rule is represented by a regular expression. For example, the regular matching rule for an average response time designed for a test document can be expressed as “.*? ([1-9]\d*\.\d+|0\.\d+|0|[1-9]\d*)(ms|s).*”.

In some examples, different regular matching rules are designed for different types of documents. For example, a type of a document includes one or more of requirements document, design document, test document, maintenance document and user manual. By designing different regular matching rules for different types of documents, it can not only meet the information extraction needs of various documents, improve the applicability of the method for extracting document information, but also help to improve the accuracy of information extraction.

For example, the regular matching rule designed for the “adequacy of response time” index in the requirements document is “.*? ([1-9]\d*\.\d+|0\.\d+|0|[1-9]\d*)(ms|s).*”.

For example, the regular matching rule designed for the “average turnaround time” index in the test document is “.*? ([1-9]\d*\.\d+|0\.\d+|0|[1-9]\d*)(ms|s).*”.

In the embodiment of the present disclosure, after the nodes in the document are classified by the machine learning model, the information of the software quality index is extracted pertinently based on the extraction rule corresponding to the classification, so that accuracy and efficiency of information extraction can be improved.

In the embodiment of the present disclosure, on one hand, by extracting not only the information contained in each node, but also the order of each node, and constructing a document tree based on the above two aspects of information, it is helpful to improve the efficiency and accuracy of subsequent document information extraction; on the other hand, compared to extract information merely rely on machine learning model or extraction rules in related art, it can improve the efficiency and accuracy of software quality index extraction by combining the machine learning model with the extraction rules, and then help to improve the automation level and accuracy of software quality evaluation.

FIG. 2 is a flowchart of constructing a document tree according to some embodiments of the present disclosure. As shown in FIG. 2, the flow of constructing a document tree comprises steps S201 to S203.

Step S201 comprises traversing nodes in a document to be processed according to an order of the nodes in the document to be processed.

For example, the order of the nodes in the document to be processed is 001, 002, 003, 004, 005, 006, wherein 001 to 003 are whole numbers of the nodes of paragraph type, 004 is a whole number of the node of table type, and 005 to 006 are whole numbers of the nodes of paragraph type. Traversing the nodes in the above order.

Step S202 comprises determining a hierarchical structure to which the nodes in the document to be processed belong according to hierarchical representation information of the nodes in the document to be processed.

In some embodiments, the hierarchical representation information of the node in the document to be processed comprises at least one of prefix information of the node or a text style of the node, and whether the node is header text.

In some examples, the header text includes heading, title, subtitle and other title types; non-header text includes list paragraph, table, template file (such as Normal) and other non-header types.

In some embodiments, a hierarchical structure to which the nodes belong is determined according to the following manner: in a case where the i-th node in the document to be processed is a header text, determining whether there is a traversed node that matches at least one of the prefix information or the text style of the i-th node, wherein i is an integer greater than 1 and less than n; if yes, the i-th node and the matched traversed node being at the same level; if no, the i-th node being the next level of the lowest level among the traversed nodes. N is the total number of nodes.

In some embodiments, determining a hierarchical structure to which the nodes belong according to the following manner: in a case where the i-th node in the document to be processed is a non-header text and the previous node of the i-th node is header text, the i-th node being the next level of the previous node.

In some embodiments, determining a hierarchical structure to which the nodes belong according to the following manner: in a case where the i-th node in the document to be processed is non-header text, determining at least one of whether prefix information of the i-th node matching prefix information of a previous node of the i-th node or whether text style of the i-th node matching text style of the previous node of the i-th node; if yes, the i-th node and the previous node of the i-th node are at the same level; if no, the i-th node is the next level of the previous node of the i-th node.

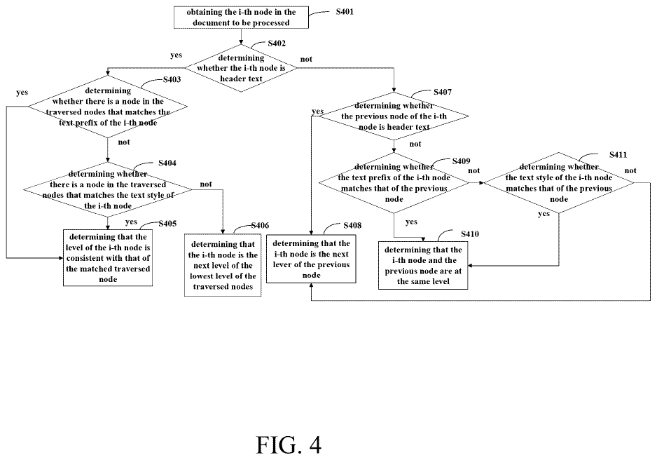

In some embodiments, the hierarchical structure to which nodes belong is determined according to the embodiment as shown in FIG. 4.

Step S203 comprises constructing a document tree according to the hierarchical structure to which nodes in the document to be processed belong and the information contained in the nodes in the document to be processed.

In the embodiment of the present disclosure, the hierarchical structure in the document to be processed is determined according to the above hierarchical representation information, and the document tree is constructed according to the hierarchical structure and node information, which is convenient for subsequently rapid and accurate information extraction.

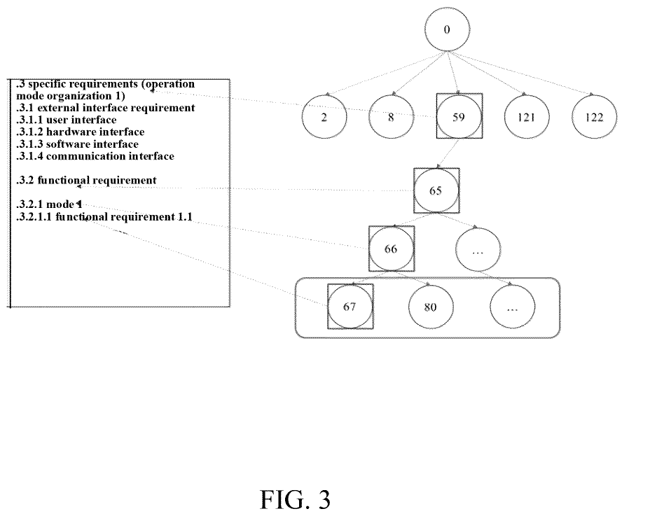

FIG. 3 is a flowchart of a document tree constructed according to some embodiments of the present disclosure. As shown in FIG. 3, the document tree comprises a plurality of nodes. In FIG. 3, circles represent nodes, numbers in circles represent the order of nodes, and relationships between nodes represent the hierarchical structure of nodes.

In some examples, in a case where it is required to extract the software quality index “number of functions considered” in the document to be processed, first, a node numbered 59 (which corresponds to “Chapter 3” in the document to be processed)is found, then child nodes of the node numbered 59 are queried, and a node numbered 65 (which corresponds to “Chapter 3.2” in the document to be processed) is found among the child nodes. Then, grandchild nodes of the node numbered 65 (which corresponds to a four-level title “3.2.X.X” in the document to be processed) are queried, and the number of its grandchild nodes is a value of “number of functions considered”.

FIG. 4 is a flowchart of determining a hierarchical structure of nodes according to some embodiments of the present disclosure. As shown in FIG. 4, the flow of determining the hierarchical structure of nodes comprises steps S401 to S411.

Step S401 comprises obtaining the i-th node in the document to be processed.

In the embodiment of the present disclosure, i is an integer greater than 1 and less than n. Besides, the node with i equal to 1 is a root node, that is, the node with the highest level. N is the total number of nodes.

In some embodiments, before performing step S401, it further comprises normalizing a format of nodes in the document to be processed. For example, the normalizing comprises normalizing a text style, text prefix, etc. in the document.

Step S402 comprises determining whether the i-th node is header text.

In a case where the i-th node is header text, step S403 is performed; in a case where the i-th node is non-header text, step S407 is performed.

Step S403 comprises determining whether there is a node in the traversed nodes that matches the text prefix of the i-th node.

If the result of the determination in step S403 is yes, step S405 is performed; if the result of the determination in step S403 is no, step S404 is performed.

For example, the prefix of the text of the i-th node is “3.2”, which matches the node with the text prefix of “3.1” existing in the traversed nodes. Here, step S405 is performed.

For example, the text prefix of the i-th node is “3.1”, and there is no node in the traversed nodes that matches the text prefix of the i-th node. Here, step S404 is performed.

Step S404 comprises determining whether there is a node in the traversed nodes that matches the text style of the i-th node.

If the result of the determination in step S404 is yes, step S405 is performed; otherwise, step S406 is performed.

For example, the text style of the i-th node is font number three, bold and indented by 2 characters. If there is a node in the traversed nodes that matches the text style of the i-th node, step S405 is performed; otherwise, step S406 is performed.

Step S405 comprises determining that the level of the i-th node is consistent with that of the matched traversed node.

Step S406 comprises determining that the i-th node is the next level of the lowest level of the traversed nodes.

For example, in a case where the lowest level of the traversed nodes is the third level, the i-th node is regarded as the fourth level.

Step S407 comprises determining whether the previous node of the i-th node is header text.

If the result of the determination in step S407 is yes, step S408 is performed; otherwise, step S409 is performed.

Step S408 comprises determining that the i-th node is the next lever of the previous node.

Step S409 comprises determining whether the text prefix of the i-th node matches that of the previous node.

If the result of the determination in step S409 is yes, step S410 is performed; otherwise, step S411 is performed.

Step S410 comprises determining that the i-th node and the previous node are at the same level.

Step S411 comprises determining whether the text style of the i-th node matches that of the previous node.

If the result of the determination in step S411 is yes, step S410 is performed, that is, it is determined that the i-th node and the previous node are at the same level; otherwise, step S408 is performed, that is, it is determined that the i-th node is the next level of the previous node.

In the embodiment of the present disclosure, the document tree corresponding to the document to be processed can be quickly constructed through the above flow, thereby facilitating subsequent information extraction based on the document tree.

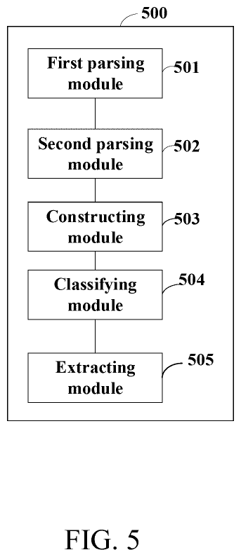

FIG. 5 is a schematic structural block diagram of a device for extracting document information according to some embodiments of the present disclosure. As shown in FIG. 5, the device for extracting document information 500 comprises a first parsing module 501, a second parsing module 502, a constructing module 503, a classifying module 504, and an extracting module 505.

The first parsing module 501 is configured for performing a first parsing on a document to be processed to obtain an order of nodes in the document to be processed.

In some embodiments, the document to be processed includes one or more of requirements document, design document, test document, maintenance document and user manual.

In some embodiments, the first parsing module 501 obtains an order of nodes in the document to be processed according to the following manner: modifying a suffix of the document to be processed to a compressed file format to obtain a compressed package; decompressing the compressed package to obtain a target folder, the target folder comprising a document file in XML format; and parsing the document file in XML format to obtain the order of nodes in the document to be processed.

The second parsing module 502 is configured for performing a second parsing on the document to be processed to obtain information contained in the nodes in the document to be processed.

In some embodiments, the second parsing module 502 obtains information contained in the nodes in the document to be processed according to the following manner: constructing a document object instance based on the document to be processed; and extracting information contained in the nodes from the document object instance, according to types of the nodes in the document to be processed.

The constructing module 503 is configured for constructing a document tree according to the order of the nodes in the document to be processed and the information contained in the nodes in the document to be processed.

In some embodiments, the constructing module 503 constructs a document tree according to the following manner: traversing the nodes in the document to be processed according to the order of the nodes in the document to be processed; determining a hierarchical structure to which the nodes in the document to be processed belong, according to the hierarchical representation information of the nodes in the document to be processed; and constructing the document tree according to the hierarchical structure to which the nodes in the document to be processed belong and the information contained in the nodes in the document to be processed.

The classifying module 504 is configured for determining a category of a software quality index to which one of the nodes in the document tree belongs, based on a trained machine learning model.

The extracting module 505 is configured for extracting information of the software quality index from the nodes in the document tree according to an extraction rule corresponding to the category of the software quality index.

In the embodiment of the present disclosure, the efficiency and accuracy of software quality index extraction can be improved through the above device, thereby facilitating the improvement of the automation level and accuracy of software quality evaluation.

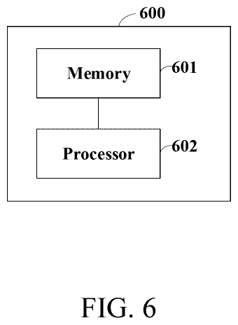

FIG. 6 is a schematic structural diagram of a device for extracting document information according to some other embodiments of the present disclosure.

As shown in FIG. 6, the device for extracting document information 600 comprises a memory 601; and a processor 602 coupled to the memory 601. The memory 601 is configured to store an instruction for implementing an embodiment corresponding to the method for extracting document information. The processor 602 is configured to execute the method for extracting document information in any of the embodiments of the present disclosure based on the instruction stored in the memory 601.

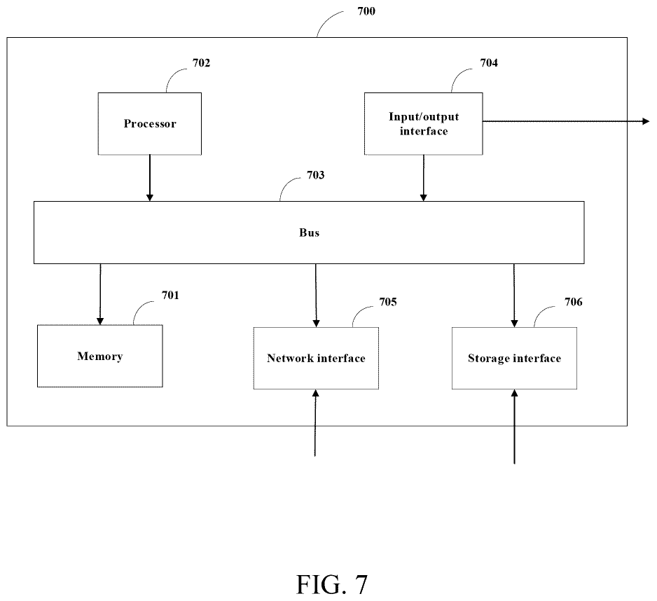

FIG. 7 is a schematic structural diagram of a computer system according to some embodiments of the present disclosure.

As shown in FIG. 7, the computer system 700 can be represented in the form of a general-purpose computing device. The computer system 700 comprises a memory 701, a processor 702 and a bus 703 connecting different system components.

The memory 701 comprises, for example, a system memory, a nonvolatile storage medium, and the like. The system memory stores, for example, an operating system, an application program, a Boot Loader program and other programs. The system memory may comprise volatile storage media such as a random access memory (RAM) and/or a cache memory. The nonvolatile storage medium stores, for example, the instruction of the embodiment of at least one method for extracting document information in implementation. A non-volatile storage medium includes, but is not limited to, a disk storage, an optical storage, a flash memory, or the like.

The processor 702 can be realized in the form of a general processor, a digital signal processor (DSP), an application specific integrated circuit (ASIC), a field programmable gate array (FPGA) or any other programmable logic device, a discrete hardware component such as discrete gate or transistor. Accordingly, each module, such as the first parsing module, the second parsing module, the constructing module, the classifying module, the extracting module, can be realized by a central processing unit (CPU) running an instruction to execute corresponding steps in a memory, or by a dedicated circuit to implementing corresponding steps.

The bus 703 may use any of a variety of bus structures. For example, the bus structure includes, but is not limited to, an Industry Standard Architecture (ISA) bus, a Microchannel Architecture (MCA) bus and a Peripheral Component Interconnection (PCI) bus.

These interfaces 704, 705, 706 and the memory 701 and the processor 702 of the computer system 700 can be connected through the bus 703. The input/output interface 704 can provide a connection interface for an input/output device such as a display, a mouse and a keyboard. The network interface 705 provides a connection interface for various networked devices. The storage interface 706 provides a connection interface for an external storage device such as a floppy disk, a USB flash drive or an SD card.

Various aspects of the present disclosure are described herein with reference to flowcharts and/or block diagrams of methods, devices and computer program products according to embodiments of the present disclosure. It should be understood that each block of the flowchart and/or block diagram, and combinations of blocks, can be implemented by computer-readable program instructions.

These computer-readable program instructions may be provided to a processor of a general-purpose computer, special-purpose computer or other programmable apparatus to produce a machine, such that the instructions, when executed through the processor, produce a device which implements functions specified in the flowchart and/or block diagram block or blocks.

These computer-readable program instructions may also be stored in a computer-readable memory that cause a computer to function in a particular manner to produce an article of manufacture, including instructions that implement the functions specified in the flowchart and/or block diagram block or blocks.

The present disclosure may take the form of an entirely hardware embodiment, an entirely software embodiment or an embodiment combining software and hardware aspects.

Through the method for extracting document information, device and storage medium in the above embodiments, the accuracy and efficiency of software quality index information extraction can be improved.

So far, the method for extracting document information, device and storage medium according to the present disclosure have been described in detail. In order to avoid obscuring the concepts of the present disclosure, some details that are commonly known in the art have not been described. Those skilled in the art can fully understand how to implement the technical solutions disclosed here according to the above description.

1. A method for extracting document information, comprising:
performing a first parsing on a document to be processed to obtain an order of nodes in the document to be processed;
performing a second parsing on the document to be processed to obtain information contained in the nodes in the document to be processed;
constructing a document tree according to the order of the nodes in the document to be processed and the information contained in the nodes in the document to be processed;
determining a category of a software quality index to which one of the nodes in the document tree belongs, based on a trained machine learning model; and
extracting information of the software quality index from the nodes in the document tree according to an extraction rule corresponding to the category of the software quality index.

2. The method for extracting document information according to claim 1, wherein the determining a category of a software quality index to which one of the nodes in the document tree belongs, based on a trained machine learning model comprises:
constructing an input vector according to the order of the nodes in the document to be processed and the information contained in the nodes in the document to be processed; and
processing the input vector by using the trained machine learning model, to obtain the category of the software quality index to which one of the nodes in the document tree belongs.

3. The method for extracting document information according to claim 2, wherein the trained machine learning model is a bidirectional encoder representations from transformers model.

4. The method for extracting document information according to claim 1, wherein the document to be processed is a word document, and the performing a second parsing on the document to be processed to obtain information contained in the nodes in the document to be processed comprises:
constructing a document object instance based on the document to be processed; and
extracting information contained in the nodes from the document object instance, according to types of the nodes in the document to be processed.

5. The method for extracting document information according to claim 4, wherein:
the types of the nodes comprise at least one of paragraph, table or directory; and
the type of the paragraph comprises at least one of picture or text.

6. The method for extracting document information according to claim 1, wherein the information of the nodes comprises hierarchical representation information of the nodes, and the constructing a document tree according to the order of nodes in the document to be processed and the information contained in the nodes in the document to be processed comprises:
traversing nodes in the document to be processed according to the order of the nodes in the document to be processed;
determining a hierarchical structure to which the nodes in the document to be processed belong according to the hierarchical representation information of the nodes in the document to be processed; and
constructing the document tree according to the hierarchical structure to which the nodes in the document to be processed belong and the information contained in the nodes in the document to be processed.

7. The method for extracting document information according to claim 6, wherein the hierarchical representation information of the nodes comprises at least one of prefix information of the nodes or a text style of the nodes, and whether the nodes are header text.

8. The method for extracting document information according to claim 7, wherein the determining a hierarchical structure to which the nodes in the document to be processed belong, according to the hierarchical representation information of the nodes in the document to be processed comprises:
in a case where the i-th node in the document to be processed is header text, determining whether there is a traversed node that matches at least one of the prefix information or the text style of the i-th node, wherein i is an integer greater than 1 and less than N, wherein N is a total number of nodes;
in a case where there is the traversed node that matches at least one of the prefix information or the text style of the i-th node, the i-th node and the matched traversed node are at a same level;
in a case where there is no traversed node that matches at least one of the prefix information or the text style of the i-th node, the i-th node is a next level of a lowest level among the traversed nodes.

9. The method for extracting document information according to claim 8, wherein the determining a hierarchical structure to which the nodes in the document to be processed belong, according to the hierarchical representation information of the nodes in the document to be processed further comprises:
in a case where the i-th node in the document to be processed is non-header text and the previous node of the i-th node is header text, the i-th node is a next level of the previous node.

10. The method for extracting document information according to claim 8, wherein the determining a hierarchical structure to which the nodes in the document to be processed belong, according to the hierarchical representation information of the nodes in the document to be processed further comprises:
in a case where the i-th node in the document to be processed is non-header text, and the previous node of the i-th node is non-header text, determining at least one of whether the prefix information of the i-th node matching the prefix information of a previous node of the i-th node or whether the text style of the i-th node matching the text style of the previous node of the i-th node;
in a case where the determination of at least one of whether the prefix information of the i-th node matching the prefix information of a previous node of the i-th node or whether the text style of the i-th node matching the text style of the previous node of the i-th node is yes, the i-th node and the previous node of the i-th node are at a same level;
in a case where the determination of at least one of whether the prefix information of the i-th node matching the prefix information of a previous node of the i-th node or whether the text style of the i-th node matching the text style of the previous node of the i-th node is no, the i-th node is a next level of the previous node of the i-th node.

11. The method for extracting document information according to claim 1, wherein the document to be processed is a word document, and the performing a first parsing on a document to be processed to obtain an order of nodes in the document to be processed comprises:
modifying a suffix of the document to be processed to a compressed file format to obtain a compressed package;
decompressing the compressed package to obtain a target folder, the target folder comprising a document file in XML format; and
parsing the document file in XML format to obtain the order of nodes in the document to be processed.

12. The method for extracting document information according to claim 1, wherein the extraction rule comprises a regular matching rule.

13. (canceled)

14. A device for extracting document information, comprising:
a memory; and
a processor coupled to the memory, the processor being configured to, based on instructions stored in the memory, implement ta method for extracting document information comprising:
performing a first parsing on a document to be processed to obtain an order of nodes in the document to be processed;
performing a second parsing on the document to be processed to obtain information contained in the nodes in the document to be processed;
constructing a document tree according to the order of the nodes in the document to be processed and the information contained in the nodes in the document to be processed;
determining a category of a software quality index which one of the nodes in the document tree belongs, based on a trained machine learning model; and
extracting information of the software quality index from the nodes in the document tree according to an extraction rule corresponding to the category of the software quality index.

15. A non-transitory computer readable storable medium having stored thereon computer program instructions which, when executed by a processor, implement a method for extracting document information comprising:
performing a first parsing on a document to be processed to obtain an order of nodes in the document to be processed;
performing a second parsing on the document to be processed to obtain information contained in the nodes in the document to be processed;
constructing a document tree according to the order of the nodes in the document to be processed and the information contained in the nodes in the document to be processed;
determining a category of a software quality index which one of the nodes in the document tree belongs, based on a trained machine learning model; and
extracting information of the software quality index from the nodes in the document tree according to an extraction rule corresponding to the category of the software quality index.

16. The device for extracting document information to claim 14, wherein to determine a category of a software quality index to which one of the nodes in the document tree belongs, the processor is configured for:
constructing an input vector according to the order of the nodes in the document to be processed and the information contained in the nodes in the document to be processed; and
processing the input vector by using the trained machine learning model, to obtain the category of the software quality index to which one of the nodes in the document tree belongs.

17. The device for extracting document information according to claim 16, wherein the trained machine learning model is bidirectional encoder representations from transformers model.

18. The device for extracting document information according to claim 14, wherein the document to be processed is a word document, and to perform a second parsing on the document to be processed to obtain information contained in the nodes in the document to be processed, the processor is configured for;
constructing a document object instance based on the document to be processed; and
extracting information contained in the nodes from the document object instance, according to types of the nodes in the document to be processed.

19. The non-transitory computer readable storable medium according to claim 15, wherein to determine a category of software quality index which one of the nodes in the document tree belongs, the instructions when executed by the processor cause the processor to:
construct an input vector according to the order of the nodes in the document to be processed and the information contained in the nodes in the document to be processed; and
process the input vector by using the trained machine learning model, to obtain the category of the software quality index to which one of the nodes in the document tree belongs.

20. The non-transitory computer readable storable medium according to claim 19, wherein the trained machine learning model is a bidirectional encoder representations from transformers model.

21. The non-transitory computer readable storable medium according to claim 15, wherein the document to be processed is a word document, and to perform a second parsing on the document to be processed to obtain information contained in the nodes in the document to be processed, the instructions when executed by the processor cause the processor to:
construct a document object instance based on the document to be processed; and
extract information contained in the nodes from the document object instance, according to types of the nodes in the document to be processed.
